(19) United States
(12) Patent Application Publication
(10) Pub. No.: US 2023/0146558 A1
(43) Pub. Date: May 11, 2023

(54) Secure Pairing for Payment Devices

(71) Applicant: ExtoLabs, LLC, Topanga, CA (US)

(72) Inventors: Timothy Dorcey, Santa Monica, CA (US); Orang Dialameh, Topanga, CA (US)

(73) Assignee: ExtoLabs, LLC, Topanga, CA (US)

(21) Appl. No.: 18/053,330

(22) Filed: Nov. 7, 2022

Related U.S. Application Data
(60) Provisional application No. 63/263,682, filed on Nov. 7, 2021.

(51) Int. Cl. G06Q 20/40; G06Q 20/20; H04L 9/08; H04L 9/32

(52) U.S. Cl. CPC G06Q 20/401; G06Q 20/20; H04L 9/0825; H04L 9/3263; G06Q 2220/00; H04L 2209/56

(57) ABSTRACT

At least one of a user-buyer device or a point of sale (POS) device having a UI (user interface) is configured with hardware, software, or algorithmic protocols, configurations, and safeguards that combat attempted unauthorized activity and theft by malicious attackers. Such configurations are in place to safeguard transactions between an authenticated buyer-user device and a POS device. Using digital certificates at one or both of the POS device or buyer device enables the other party to verify the other party and ensure that some malicious device has not intercepted communications or performed some man-in-the-middle attack.

### CROSS-REFERENCES TO RELATED APPLICATIONS

This Non-Provisional Application claims the benefit of and priority to U.S. Provisional Application Ser. No. 63/263,682, filed Nov. 7, 2021, entitled “ExtoPay,” the entire contents of which is hereby incorporated herein by reference.

### BACKGROUND

Bluetooth Low Energy (BLE) provides an attractive wireless communication channel due to its low power requirements and ubiquity on mobile phones. However, with a range on the order of 10 meters and the ability to pass through walls, it can be difficult to ensure a connection is between the intended devices. These problems can be easily addressed if each device carries its own display and user input features, such as a fingerprint sensor or numeric keypad. The display, user input and fingerprint sensor add significant costs to the device, both in terms of the individual component costs as well as the processing power to operate them and the complexity of arranging the components on a physical form factor. Lower-cost devices may be produced by omitting some of these components but relying on a second device to provide the necessary UI functionality. This UI device may be controlled by the transaction counterparty, as in the familiar credit card point-of-sale device. Or, it may be a device such as a smartphone or a feature phone owned by the user. Or, it could be like a merchant point-of-sale device but not restricted to transactions with the merchant. Meanwhile, control of the private keys and transaction signing remains on the low-cost device.

Each of these scenarios presents unique operational and security challenges. In the case where the counterparty controls the UI device, there are obvious motives for theft. For example, if the low-cost user device is without a display, the UI device could display one amount while charging a larger amount. Or, if the user is required to enter their PIN or fingerprint into the UI device, these could be recorded in a database. While the PIN for fingerprint alone would not allow theft of funds without the user device holding the private key, the database may be later utilized with lost or stolen devices. Or, the same PIN or fingerprint might be used to authorize entirely independent services of high value.

### SUMMARY

At least one of a user-buyer device or a point of sale (POS) device having a UI (user interface) is configured with hardware, software, or algorithmic protocols, configurations, and safeguards that combat attempted unauthorized activity and theft by malicious attackers. Such configurations are in place to safeguard transactions between an authenticated buyer-user device and a POS device. Using digital certificates at one or both of the POS device or buyer device enables the other party to verify the other party and ensure that some malicious device has not intercepted communications or performed some man-in-the-middle attack.

Configuring digital certificates or other certificates with codes, personally identifying information, PIN (personal identification number) or biometric requirements can help the buyer-user verify that their device is connected to and authorize a transaction at the POS device. Furthermore, using a set of approved digital certificates from a payment service provider ensures the buyer and counterparty (e.g., point of sale user) communicate with a verified source. Leveraging QR (quick response) codes or randomly generated codes coupled with the buyer device's unique digital certificate even further ensures that the POS device is connected to the correct and intended buyer.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. These and various other features will be apparent from a reading of the following Detailed Description and a review of the associated drawings.

DESCRIPTION OF THE DRAWINGS

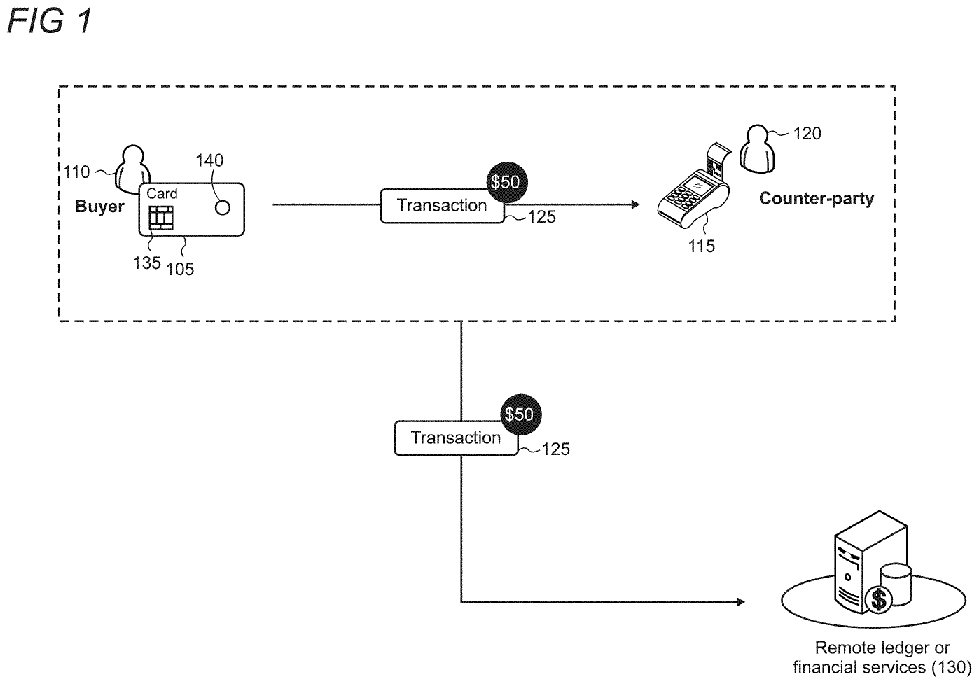

FIG. 1 shows an illustrative representation of an executed transaction between two parties recorded at a remote service;

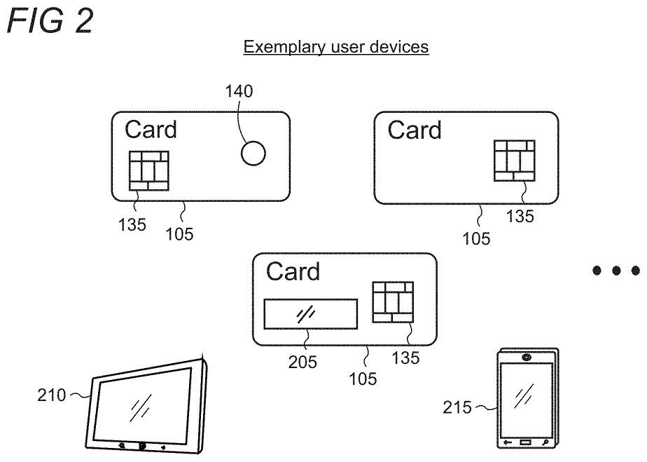

FIG. 2 shows illustrative user devices that may be used to purchase items at a counterparty or point of sale (POS) device;

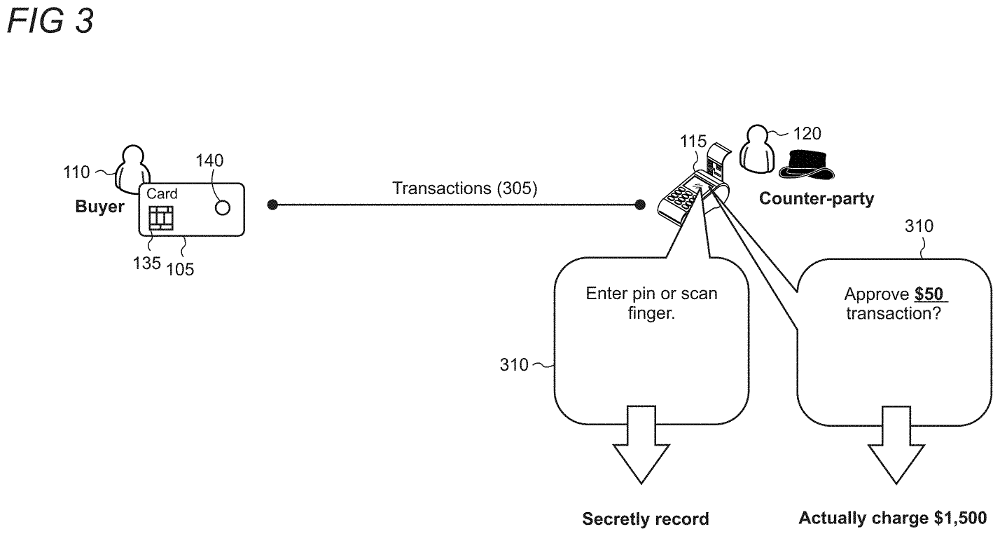

FIG. 3 shows an illustrative representation of a malicious counterparty stealing from an honest buyer;

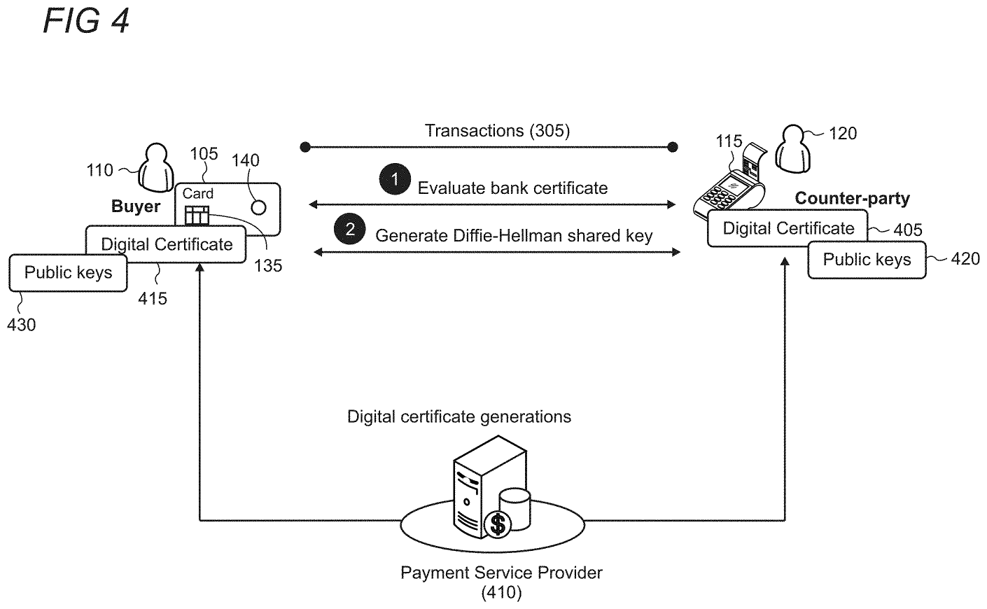

FIG. 4 shows an illustrative representation of a ‘buyer’s user device verifying a counterparties digital certificate;

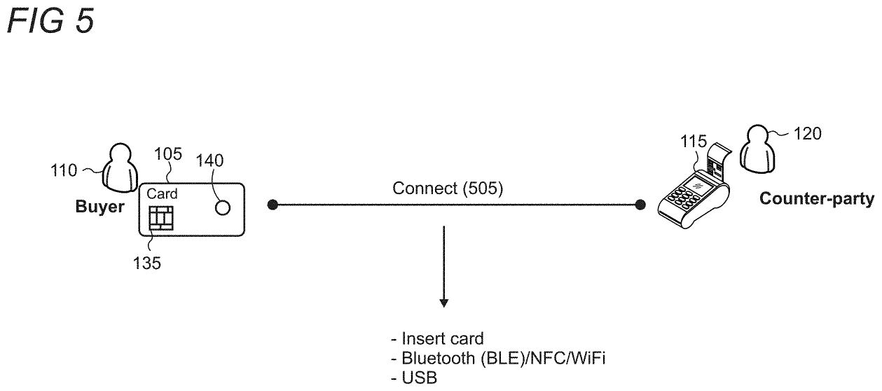

FIG. 5 shows an illustrative representation of exemplary connection mechanisms between a user device and POS device;

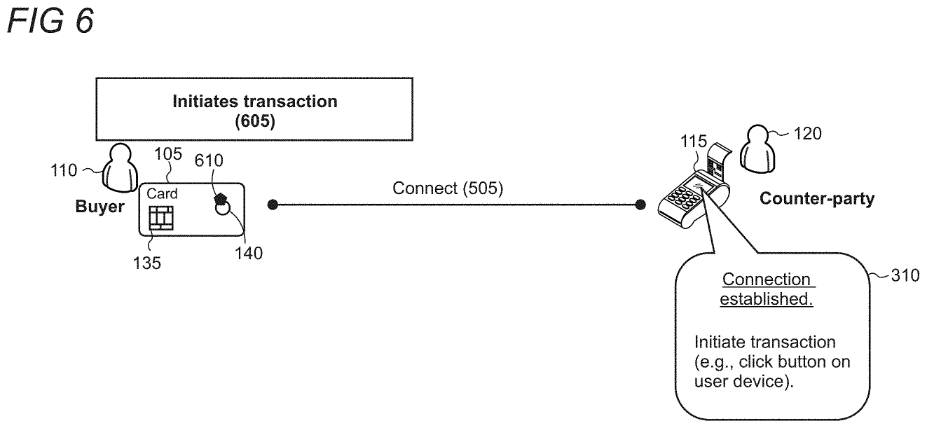

FIG. 6 shows an illustrative representation of the user entering an input at their user device upon establishing a connection with a POS device;

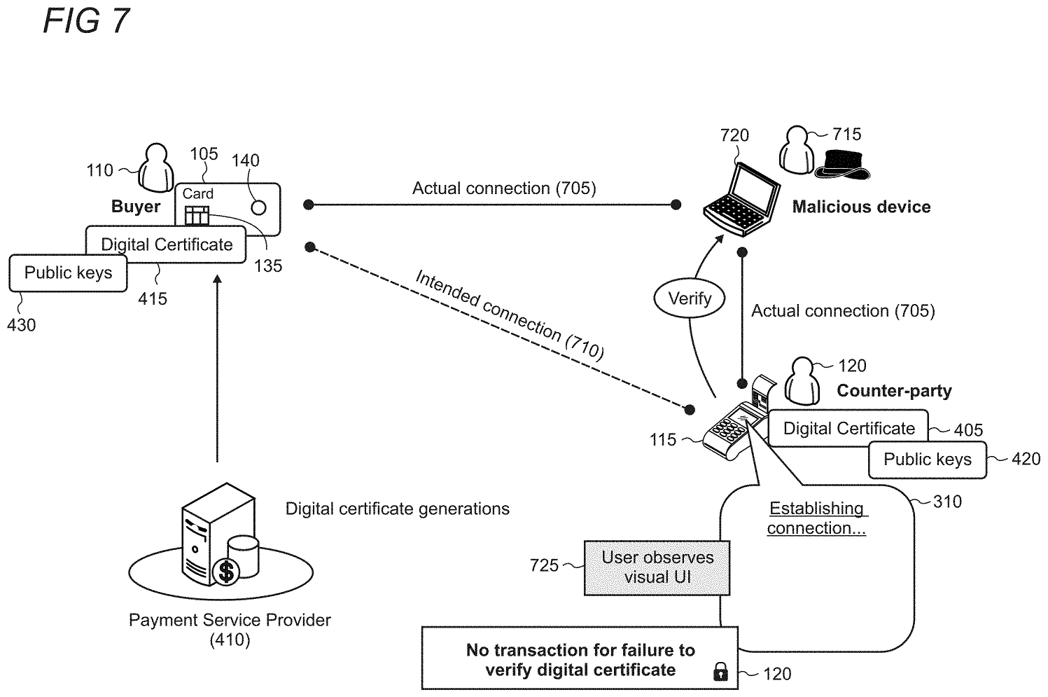

FIG. 7 shows an illustrative representation of a malicious POS device interfering with the user's device's connection to an intended POS device;

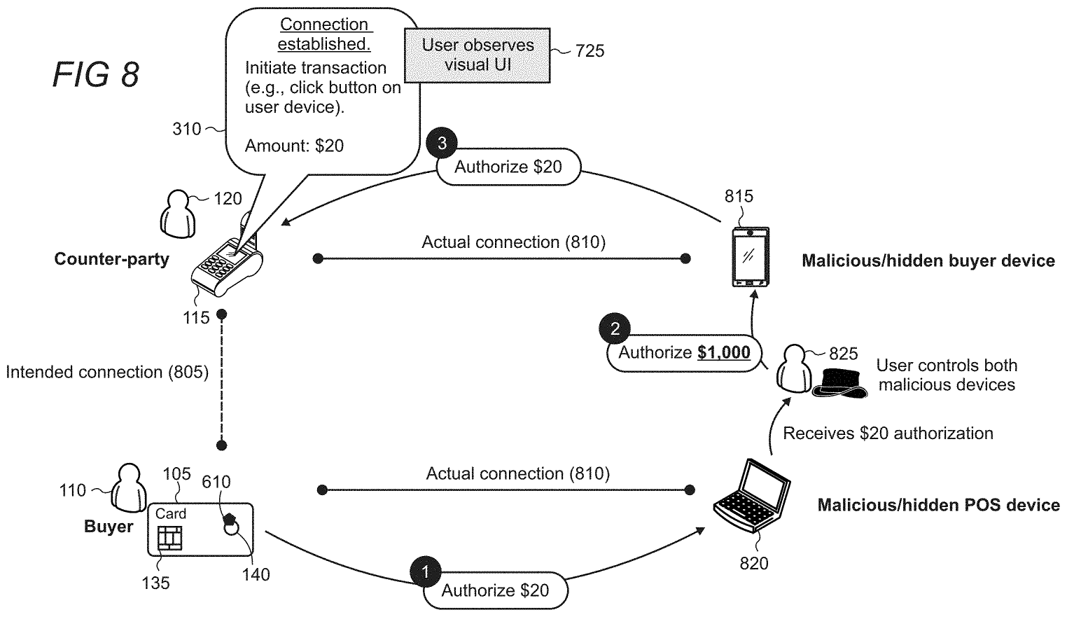

FIG. 8 shows an illustrative representation of malicious buyer and POS devices interfering with the authentic buyer ‘device’s connection with an authentic POS device;

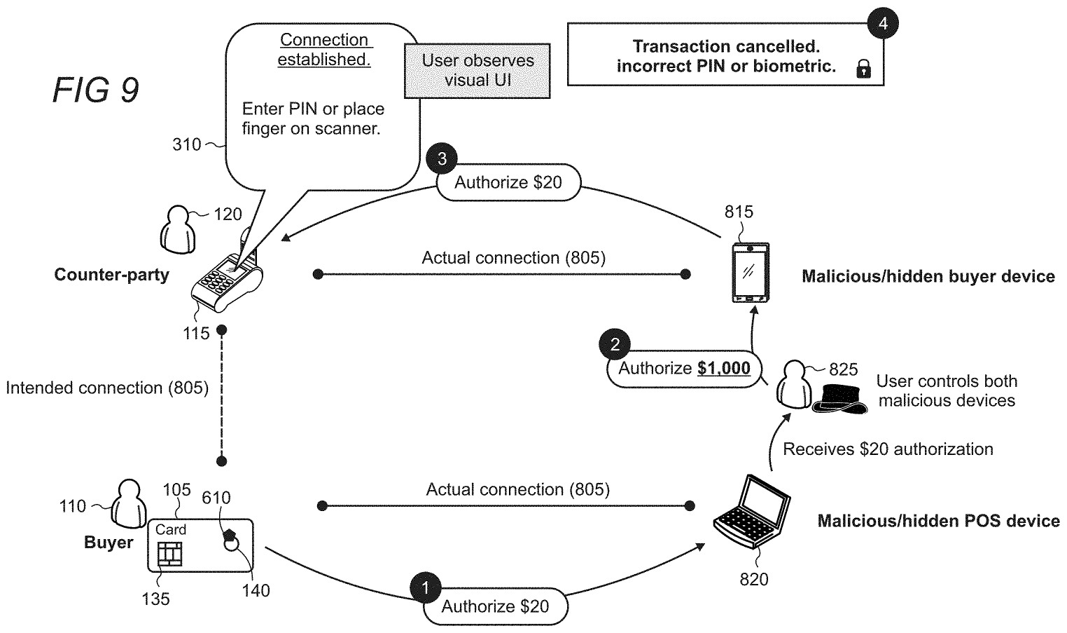

FIG. 9 shows an illustrative representation of the utilization of a PIN (personal identification code) or biometric scan to verify the authenticity of the user;

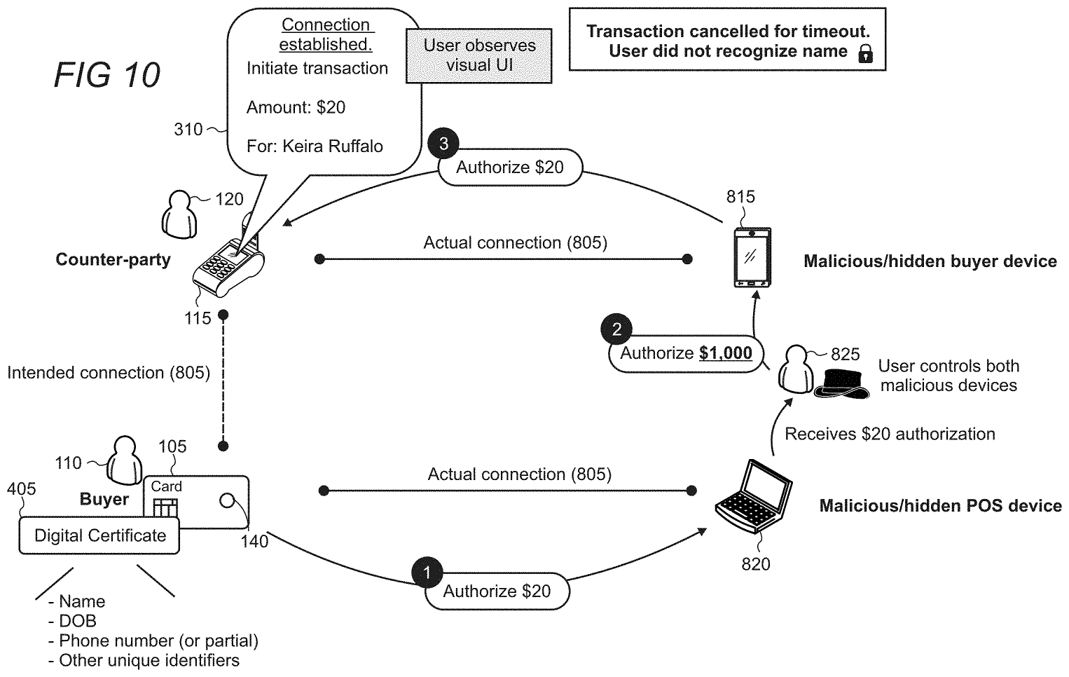

FIG. 10 shows an illustrative representation of digital certificates being configured with additional information for user verification at the authentic POS device;

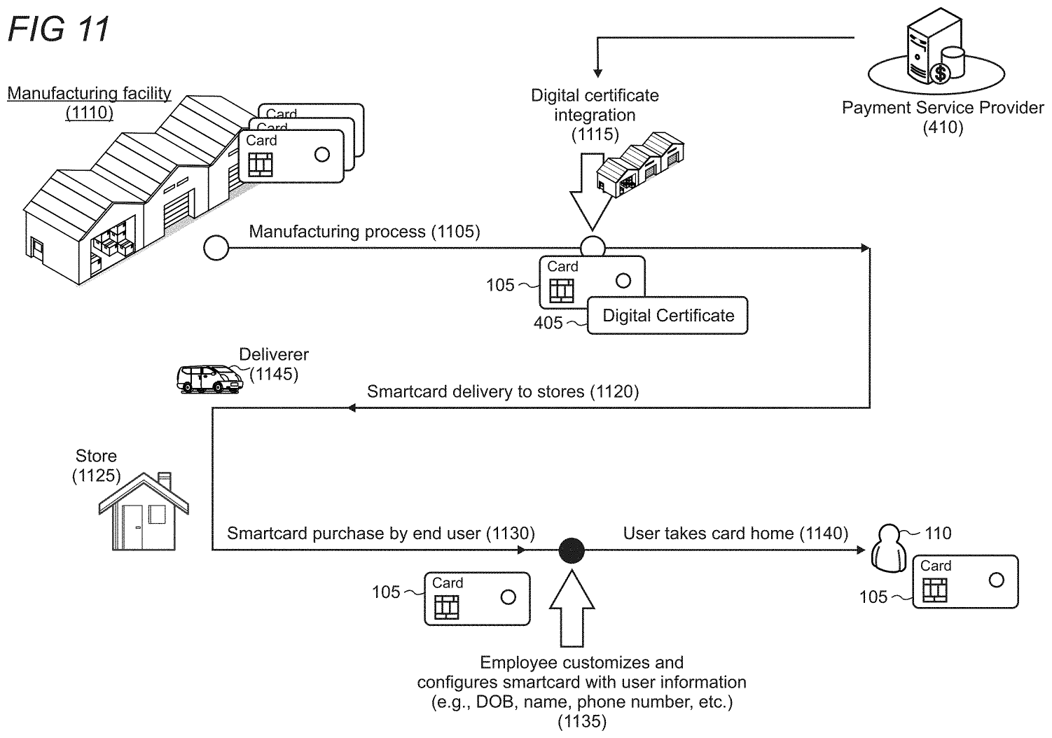

FIG. 11 shows an illustrative representation of the manufacturing process of a smartcard or other user device;

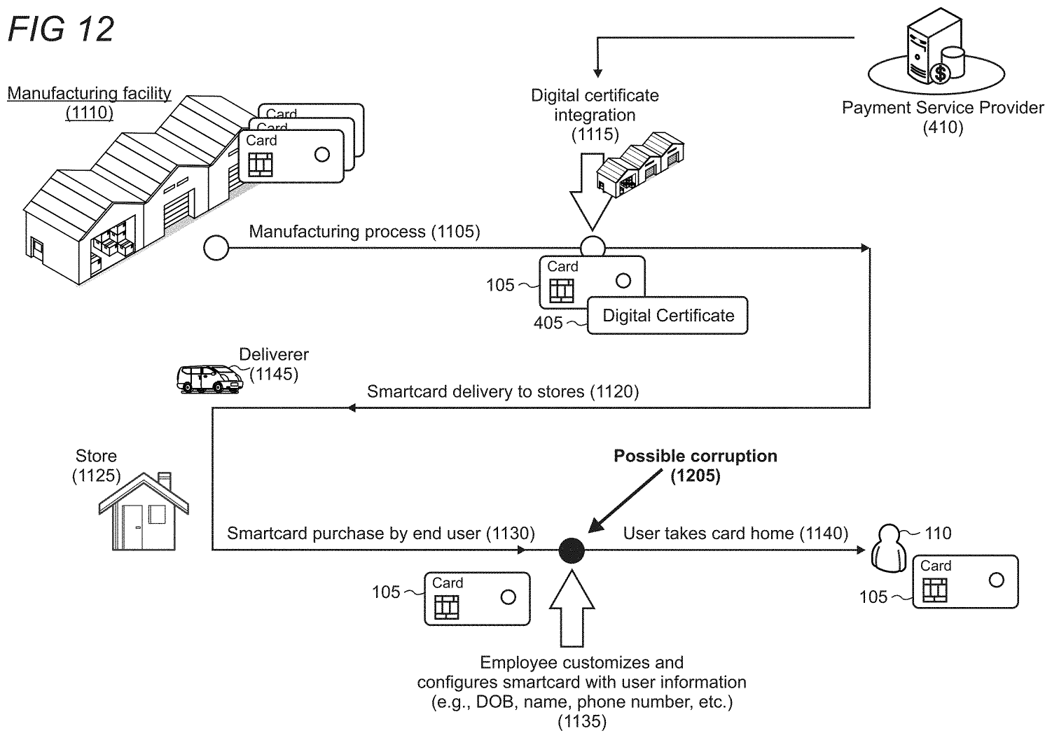

FIG. 12 shows an illustrative representation of possible corruption within the manufacturing process;

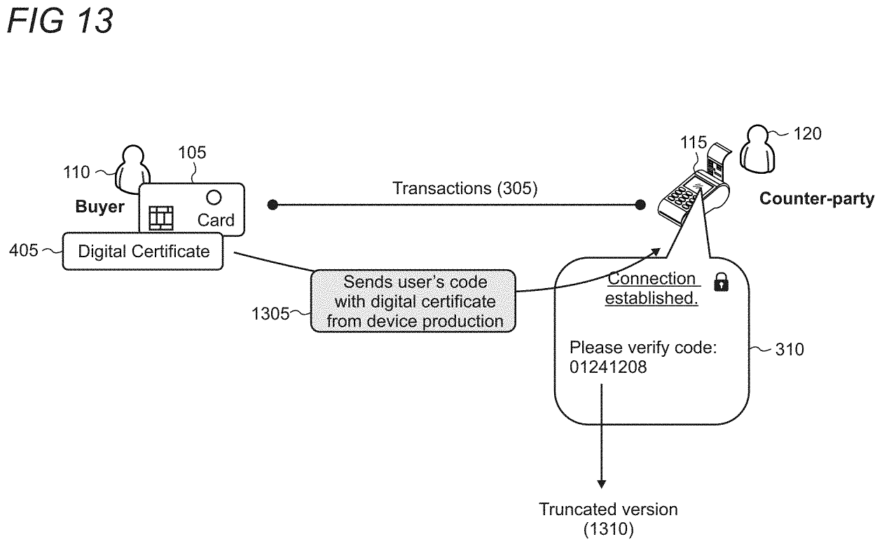

FIG. 13 shows an illustrative representation of an authentic buyer ‘device’s digital certificate configured with a unique code for verification at the POS device;

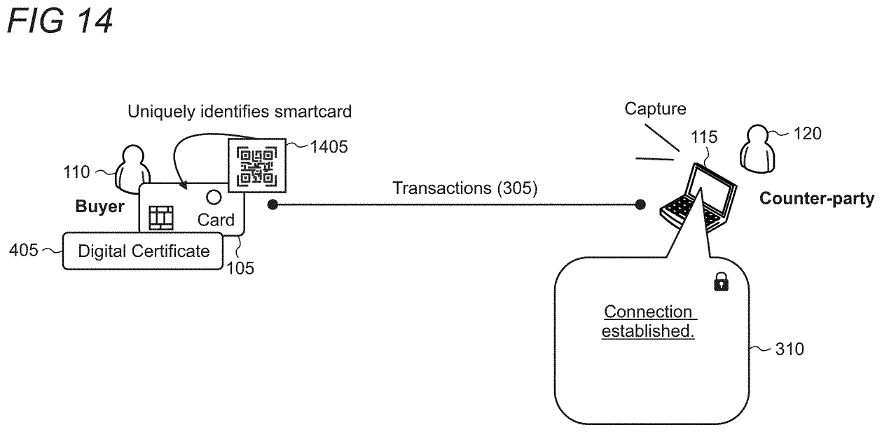

FIG. 14 shows an illustrative representation of utilizing a QR (quick response) code at a buyer device to authenticate the user device's digital certificate;

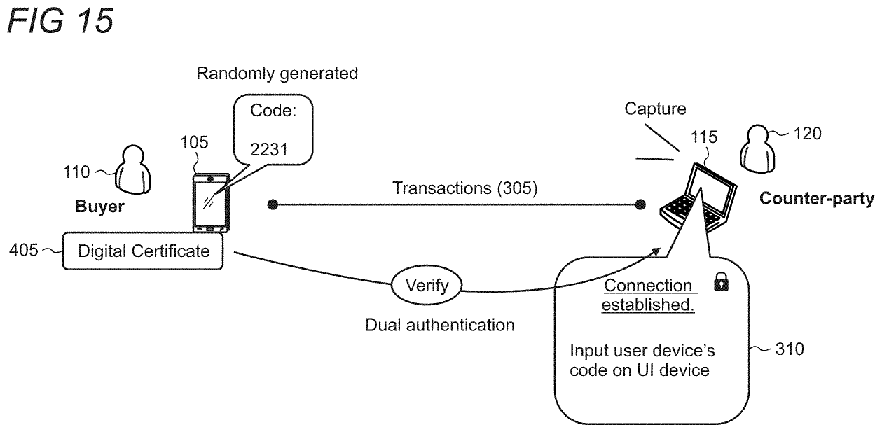

FIG. 15 shows an illustrative representation of utilizing a randomly generated code so the POS device can uniquely identify the buyer device;

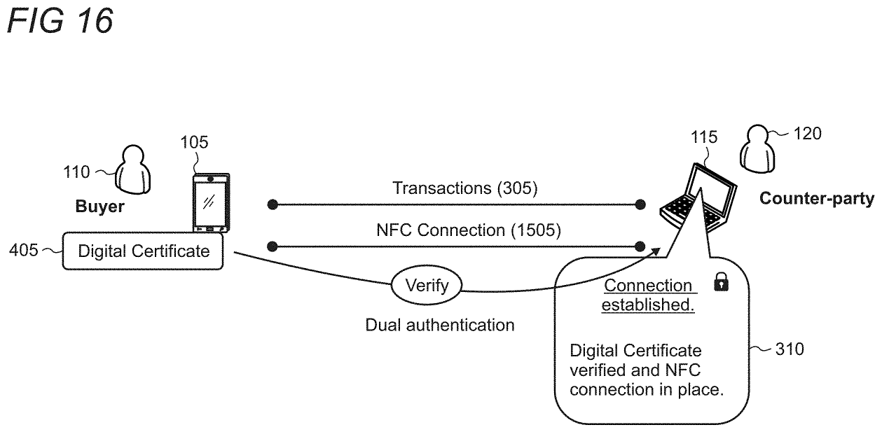

FIG. 16 shows an illustrative representation of utilizing an NFC (near field communication) connection so the POS device can uniquely identify the buyer device;

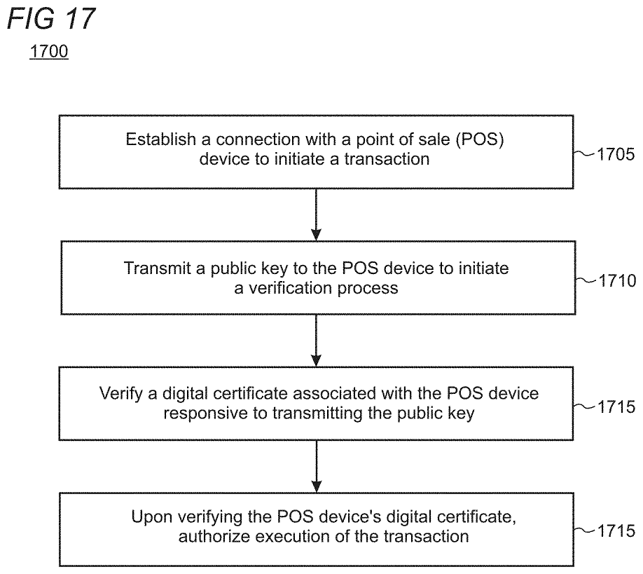

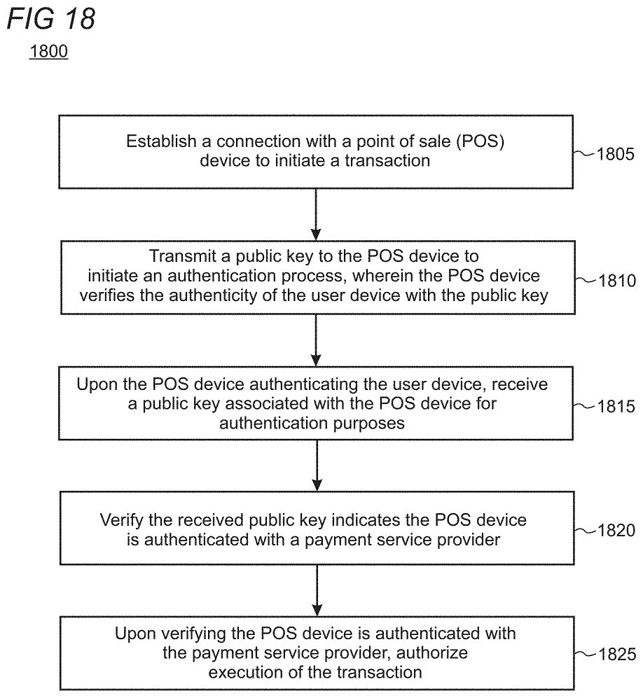

FIGS. 17-18 show illustrative flowcharts of the system leveraging hardware and software configurations to safeguard multi-party transactions from malicious attacks;

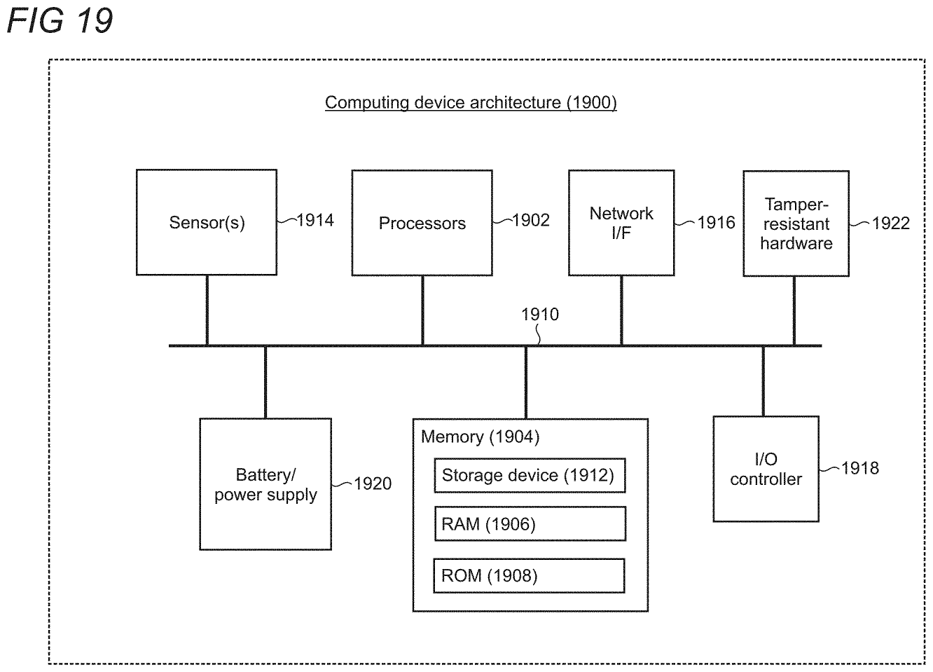

FIG. 19 shows a simplified block diagram of a computing device that may be used to implement the present secure pairing for payment devices; and

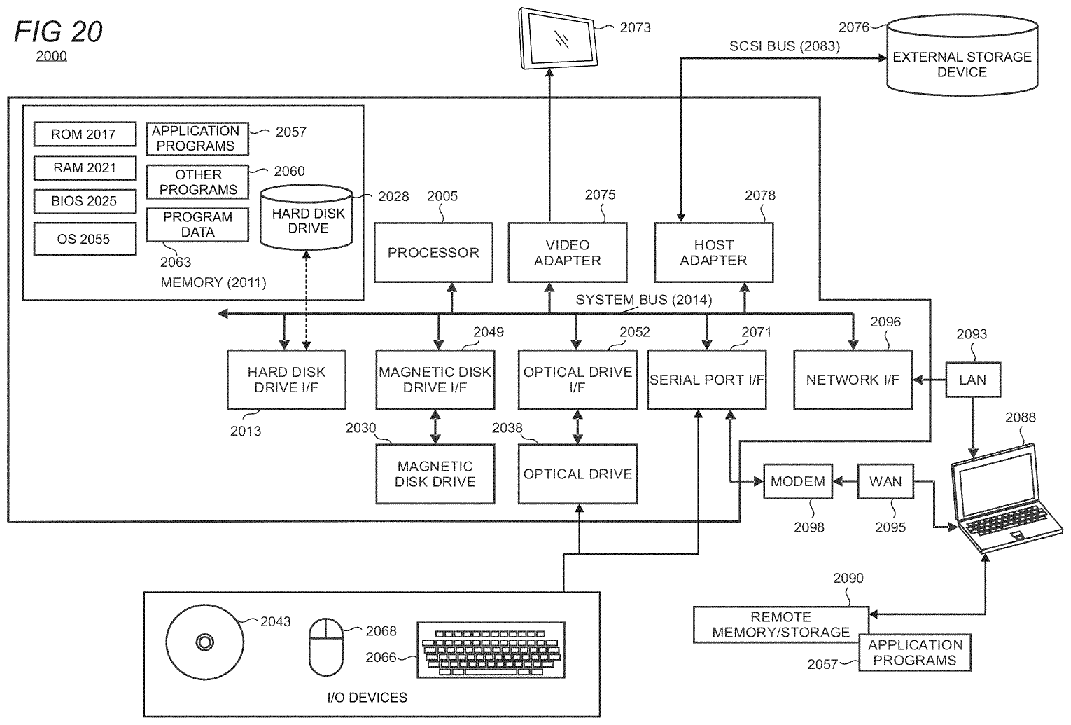

FIG. 20 shows a simplified block diagram of a computing device that may be used to implement the present secure pairing for payment devices.

Like reference numerals indicate like elements in the drawings. Elements are not drawn to scale unless otherwise indicated.

### DETAILED DESCRIPTION

FIG. 1 shows an illustrative representation in which a buyer 110 executes a transaction with counterparty 120 and the transaction 125 is recorded with a remote ledger service or a financial service (individually and collectively represented by reference numeral 130). In a typical scenario, the buyer-user may attempt to execute a transaction with a counterparty, which can include a retail store, restaurant, service store, etc. The user 110 may use their smartcard or another capable device to transfer money to the ‘counterparty’s POS (point of sale) device 115 in exchange for goods or services. This transaction, once complete, may involve contacting and/or recording the transaction with a remote ledger service and/or a financial service, such as one or both parties' banks. A description for executing these transactions and recording them remotely can be viewed in U.S. Pat. No. 11,301,554, entitled Secure Tamper Resistant Smart Card,” filed Mar. 13, 2019, and U.S. application Ser. No. 17/449,677, entitled “Leveraging Tamper-Resistant Hardware to Transfer Digital Currency between Local Devices,” filed Oct. 1, 2021, the entire contents of both applications of which are hereby incorporated herein by reference.

The buyer device 105, in this example, is a smartcard configured with a chip 135 and a button 140 that the user 110 can press to initiate transactions or execute other programmed functions. The smartcard 105 may be configured similarly as discussed in U.S. Pat. No. 11,301,554, entitled “Secure Tamper Resistant Smart Card,” filed Mar. 13, 2019, the entire contents of which are hereby incorporated herein by reference. For example, the smartcard can include one or more chips (processors), hardware-based memory devices storing data and instructions, among other components and configurations disclosed in U.S. Pat. No. 11,301,554. FIG. 2 shows illustrative user devices that may be used herein, including an array of smartcards, including a smartcard without an input button 140, or a smartcard with a display interface 205. The additional configuration of the UI on the smartcard is also discussed in U.S. Pat. No. 11,301,554, referenced above, and the discussion therein is also incorporated herein by reference. Other devices that may be used can include computing devices like a tablet computer 210, smartphone 215, or other types of computing devices, including smartwatches, laptop computers, etc.

FIG. 3 shows an illustrative representation in which a user 110, using smartcard buyer device 105, initiates a transaction 305 at a POS device 115 having a user interface (UI) 310. In this regard, the disclosure herein typically focuses on scenarios in which the buyer device 105 is a ‘low-cost’ device that may not have a display or any user input control beyond a simple button. The benefit of using such a device is a low cost that makes such a device globally feasible. Low-cost payment devices are available in the form of traditional credit cards, but these generally require an expensive and highly trusted counterparty device to ensure security. This disclosure typically focuses on scenarios where the POS device is a low-power BLE (Bluetooth® low energy) device that is not necessarily trustworthy, although other forms of wired and wireless connections are also possible with the present implementation details. The low-cost buyer device may interact with a POS device 115 configured with a UI to enable some real-world communication between the buyer and counterparty. Thus, in most examples herein, a low-cost buyer device attempts a connection and transaction with a POS device having UI. Although a display screen is typically shown, other interfaces, such as speakers, a camera for capturing inputs, flashing lights, etc., are also possible.

In FIG. 3, the user 105 attempts a transaction 305 with the counterparty 210. Responsive to establishing a connection, the POS device 115 can request the user to either enter a PIN (personal identification number) or scan their finger for a biometric scan, among other user authenticating techniques (e.g., alpha-numeric password). Alternatively, the POS device may ask the user to verify that the transaction is approved for a certain amount, like $50. In both scenarios, the user cannot verify that the ‘counterparty’s device is not malicious and attempting to steal the ‘user’s credentials for future use or approve a different amount (e.g., $1,500).

FIG. 4 shows an illustrative representation in which a digital certificate 405 is generated and associated with approved POS device 115 for verification by a buyer device 105. Upon initiating the transaction 305, the user 110 may attempt to establish an authenticated, encrypted connection to the POS device 115 by sending a public key 430, along with a digital certificate 415, which has been signed by a payment service provider 410 to certify that the public key 430 belongs to an authorized buyer device 105. The digital certificate 415 may include the owner or user's name, identification of the payment service provider, the date from which the certificate is valid, an expiration date, and a serial number uniquely associated with the certificate, among other information depending on the specific implementation details. Thus, the first step shown in FIG. 4 includes evaluating bank/digital certificate to verify that the counterparty's public key belongs to an authorized account.

After verifying that the buyer public key 430 is authorized by the payment service provider 410, the POS device may return its own public key 420, along with the digital certificate 405, which a payment service provider has signed 410 to certify that the public key 420 belongs to an authorized POS device, allowing the buyer device 105 to verify that the public key 420 belongs to an authorized POS device 115. The POS device's digital certificate may be configured similarly to the buyer device's certificate. Each device may be configured with one or more pre-set public keys that enable it to authenticate that the counterparty certificate is authorized with a mutually trusted payment service provider 410. The payment service provider may be a remote service that generates secure digital certificates for authorized devices. Each device may create an account and go through a sign-up process before the provider issues a digital certificate. Thus, each device may verify that the counterparty device has a public key that has been authorized by the payment service provider and automatically aborts the payment transaction if the authorization fails. Aborting the transaction can include either one or both of the devices disconnecting from the other.

Diffie-Hellman key exchange allows two parties who share a public key with each other to derive a shared secret. Each party takes the Public Key provided by the other party and combines it with their own private key to generate a secret, which will be the same on both sides. If this key is then used in an Authenticated Encryption algorithm, a successful message exchange proves that each party knew the private key associated with the public key they shared in the initial exchange. If they didn't know the private key, they wouldn't be able to compute the same secret and the Authenticated Encryption would fail.

So, the successful Diffie-Hellman key exchange plus EAX proves the counterparty “owns” the public key they presented. If we have a digital certificate from a trusted third party, such as the payment service provider, that says the public key belongs to some unique user, then we are certain we are connected to that unique user, and there can be no man in the middle. The bank signature in the digital certificate proves that the owner of the public key in the certificate is that unique user and has whatever other properties are included in the certificate (e.g., phone number, etc.). Then, the Diffie-Hellman key exchange proves that the device currently holding that certificate knows the private key associated with that public key, thereby preventing certificate theft. Thus, the second step in FIG. 4 is to generate a Diffie-Hellman shared key for input into Authenticated Encryption algorithm, to establish a secure connection to the owner of the public key.

A Diffie-Hellman key exchange can then be used to generate a shared secret for input into an authenticated encryption scheme, such as the EAX (encrypt-then-authenticate) mode of AES (advanced encryption standard). As well as generating a shared secret, this step confirms that each device possesses the private key associated with the public key that the certificate has authorized in the preceding step. Thus, the buyer device 105 can establish a secure communication channel with an authentic POS device 115. The Diffie-Hellman key agreement is a method for two parties to agree on a shared secret without revealing this shared secret to eavesdroppers. The two parties exchange public keys, and each party then uses its own Diffie-Hellman private key with the other party's Diffie-Hellman public key to compute the same shared secret (the Diffie-Hellman shared secret). This shared secret is not revealed to eavesdroppers or malicious devices because, while they can know the public keys, they do not know the two Diffie-Hellman private keys to compute the shared secret.

FIG. 5 shows an illustrative representation in which the smartcard 105, or another buyer device, connects 505 to a POS device 115 over various methods. For example, the smartcard may be inserted into the POS device's receptacle or slot, relying on BLE, NFC (near field communication), WiFi or other over-the-air connection, or a USB (universal serial bus) or other wired connection. The connection 505 is the first step before any transaction between a user 110 and counterparty 120 can initiate. The connection is a point within the transaction that can result in malicious attacks and theft, and subsequent discussions at least partially deal with safeguarding against malicious attacks.

FIG. 6 shows an illustrative representation in which the user device 105 connects 505 with a POS device 115. In typical transactions, the UI 310 on the POS device provides some indication to the user of the transaction's progression. Here, the UI indicates that a connection was established and that the user should confirm the transaction for processing, such as by pressing an input at their user device 105. The user 110 can click/input 610 on the button 140 to initiate and execute the transaction with the POS device, as representatively illustrated by reference numeral 605. Failure to press the button within a pre-set period of time, such as 30 seconds, can result in a disconnection or transaction cancellation.

FIG. 7 shows an illustrative representation in which the user 110 intends to connect with counterparty 120, as represented by reference numeral 710. However, the buyer ‘device’s actual connection is with a malicious device 720, which may be considered a malicious POS device, malicious user device, malicious UI device, and the like. The user may not observe or be aware of the presence of a malicious device 720, but nonetheless, the user may not be able to control which device—within operational proximity—the user device connects to.

This attack is not possible because an authentic POS device 115 will not have the ability to simultaneously act in the role of a POS device and a buyer device 105. If a device has these capabilities, then the payment service provider will not grant it a certificate to act as a POS device or as a buyer device. Thus, neither the buyer device 105 nor the POS device 115 will connect to it.

FIG. 8 shows an illustrative representation in which multiple malicious devices are used to scam authenticated buyer devices 105 and POS devices 115. For example, while the authentic user and POS devices intend to connect with each other, as shown by reference numeral 805, a pair of actual connections with malicious devices may be established, as represented by reference numeral 810. The user device 105 is actually connected with malicious and hidden UI device 820 (e.g., a malicious POS device) operated by malicious user 825, and the visible POS device 115 is actually connected with a malicious and hidden user-buyer device 815 operated by malicious user 825. In typical implementations, since the malicious devices are authentic with payment provider certificates to establish connections with the visible user and POS devices 105,115, they cannot connect directly to each other. However, it is conceivable that a malicious person, or some electromechanical device, may operate both malicious devices in such a way that the visible POS device 115 appears to be responsive to inputs on the user device 105. For example, the POS device 115 may display the transaction amount as $20 and signal the connected malicious user device 815 to beep or flash a light requesting user approval. If instead of approving the transaction, the malicious person 825 operated on the hidden POS device 820 to request $1000, that would signal the user device 105 to beep or flash a light at the correct time. The user may then enter an input 610 on their device's button 140 to execute the $1000 transaction on the hidden POS device 810. Then, as soon as the hidden POS device 820 responds to the user button press, the malicious person can press the button on the hidden buyer device 815 to execute the $20 transaction displayed on the POS device 115. Thus, the authentic POS device 115 may display an executed transaction (e.g., “Approved for $20”) and the user leaves the store short $1,000, or $980 more than their intended amount.

FIGS. 9 and 10 show illustrative representations that can safeguard against malicious attacks shown in FIG. 8. In FIG. 9, the authenticated POS device 115 may be configured to request a PIN or biometric scan to authenticate the user 110. In this situation, the actually connected malicious buyer device 815 would not have a PIN or biometric scan that matches up to the authenticated user 110, resulting in the transaction being canceled for an incorrect PIN or scan. The ‘user’s input at the POS device 115 may occur before or after the user clicks the button 140.

In FIG. 10, the digital certificates 405 associated with buyer device 105 may be pre-configured with additional identifying information that is also transmitted to POS device 115. Identifying information can include the ‘user’s name, date of birth, phone number or partial number, or other identifying information. Accordingly, the POS device's UI 310 displays additional information that the authenticated user 110 can use to verify the authenticity of the transaction. For example, the UI displays the amount and the ‘user’s name. If the user does not recognize the name, then the user can choose not to click the button 140 to execute the transaction, which will result in transaction timeout and cancellation. In this scenario, since the authenticated user device 105 is not actually connected to the authenticated POS device 115, but rather the malicious buyer device 815 is connected, the authenticated POS device 115 displays the identifying information associated with the malicious buyer ‘device’s digital certificate 405. Each ‘device’s digital certificate is unique to that device. As the identifying information is encrypted with the digital certificate, the malicious buyer and POS devices are unable to steal the ‘user’s information as the authenticated POS device 115 independently verifies the unique digital certificate for each connected buyer device. A stolen certificate is useless because the thief will not know the private key that is necessary to complete the initial Diffie-Hellman key exchange.

FIG. 11 shows an illustrative representation in which a smartcard 105 or another buyer device 105 is created at a manufacturing facility 1110. During the manufacturing process 1105 of a buyer device, such as a smartcard, the facility may interoperate with a payment service provider 410 that generates and integrates the digital certificate 405 into the smartcard, as representatively illustrated by numeral 1115. Such as process helps safeguard the authenticity of the unique ‘device’s digital certificate. The devices may be connected to a local computer that is able to upload and configure the buyer devices, and the local device may have extensibility to the payment service provider. The created buyer devices may then be delivered to stores 1120 by deliverer 1145. When a user purchases or otherwise obtains the buyer device at a store 1125, as representatively illustrated by numeral 1130, an employee may be equipped to customize and configure the buyer device with user information, such as date of birth, name, phone number, etc. 1135. Then, the employee may communicate with the payment service provider to request an additional certificate that certifies the personal identifying information. Typically, this request may include the signed manufacturing certificate 405, so the payment service provider can issue a new certificate that links the personal identifying information to the existing device certificate or refuse to provide it if the manufacturing certificate 405 is not valid. From here, the user takes their new card home. Such employee-driven customization of the card can be identified as possible corruption, as shown by reference numeral 1205 in FIG. 12. For example, the employee may intentionally or unintentionally make an error or steal information for future malicious purposes.

FIG. 13 shows an illustrative representation in which a unique user code associated with the buyer device 105 is associated with the digital certificate and is output by POS devices upon connection to avoid relying on employee customizations (FIGS. 11-12). For example, a unique code or truncated version 1310 of the code with the digital certificate can be displayed on the POS device's UI 310. As these codes are generated at production and not selected by the user, in typical implementations, collisions and overlap among different users are unlikely.

FIG. 14 shows an illustrative representation in which, during production, a QR (quick response) code 1405 or other scannable or unique code is physically stamped on the buyer device 105. The QR code may be generated using some deterministic process (e.g., some deterministic algorithm based on a preceding step or input, such as the number of the card in the process) or randomly chosen with enough bits (e.g., 128) to make collision unlikely. The QR code is uniquely associated with the buyer ‘device’s digital certificate 405. A POS device 115 with a camera can capture the QR code and then uniquely identify the digital certificate associated with the QR code for connecting. If the digital certificate of the connected device does not match the referenced digital certificate in the scanned QR code, the POS device can deny the connection or transaction.

FIG. 15 shows an illustrative representation in which the buyer device 105, equipped with a UI, can display a randomly generated code. The POS device 115, upon connecting with the buyer device, prompts the user to input the randomly generated code from the user device to authenticate. The POS device may still additionally verify the unique digital certificate 405. Such dual authentication tactics can ensure that the POS device has identified, authenticated, and connected to the appropriate device. If the POS device is set up with a camera, it could capture the randomly generated code on the ‘user’s device, leverage specialized image generation processing, and verify the buyer device. This “out of band” code can then be combined with the key generated by Static Diffie-Hellman key exchange to establish a mutually authenticated secure communication channel

FIG. 16 shows an illustrative representation in which an NFC (near field communication) connection 1505 is leveraged by the POS device 115 to authenticate the buyer device 105. Standard NFC technology utilizes a high-powered device to read an unpowered device. However, the same basic technology may be adapted to transmit a randomly generated code between 2 low-powered devices. Alternatively, an optical coupling may be used to share a randomly generated code between 2 devices that are held close together to prevent any other device from intercepting the optical signal. The “out of band” NFC or optically transmitted code may be combined with the Static Diffie-Hellman key to establishing a mutually authenticated secure communication channel while eliminating the chance of connecting to any hidden devices.

FIGS. 17 and 18 show illustrative processes performed by a buyer-user computing device (e.g., smartcard), POS computing device, or a combination thereof. Although the steps are shown in sequential order, the features and actions therein may be alternatively arranged and/or certain steps may be added or removed. The process is exemplary only to show one specific implementation for understanding the present ‘disclosure’s features.

In step 1705, in FIG. 17, the user device establishes a connection with a POS device to initiate a transaction. The transaction can be, for example, the user device paying some monetary amount ($10, $20, $1,000, etc.) in exchange for goods or services from the operator of the POS device. Thus, the user can transfer $20 from the ‘user’s bank account to the POS operator's bank account. In step 1710, the user device transmits a public key to the POS device to initiate a verification process. In step 1715, the user device verifies a digital signature associated with the POS device responsive to transmitting the public key. In step 1720, upon verifying the digital certificate, the user device authorizes the execution of the transaction. Specifically, the user device authorizes a bank transfer of some amount to the POS operator's bank account.

In step 1805, in FIG. 18, the user device establishes a connection with a POS device to initiate a transaction. In step 1810, the user device transmits a public key to the POS device. In step 1815, upon the POS device authenticating the user device, the user device receives a public key associated with the POS device for authentication purposes. In step 1820, the user device verifies that the received public key indicates that the POS device is authenticated with a payment service provider. In step 1825, upon verifying the POS device, the user device authorizes the execution of the transaction.

FIG. 15 shows an illustrative architecture 1500 for a device, such as a smartphone, tablet, or laptop computer, capable of executing the various features described herein. The architecture 1500 illustrated in FIG. 15 includes one or more processors 1502 (e.g., central processing unit, dedicated AI chip, graphics processing unit, etc.), a system memory 1504, including RAM (random access memory) 1506, ROM (read-only memory) 1508, and long-term storage devices 1512. The system bus 1510 operatively and functionally couples the components in the architecture 1500. A basic input/output system containing the basic routines that help to transfer information between elements within the architecture 1500, such as during startup, is typically stored in the ROM 1508. The architecture 1500 further includes a long-term storage device 1512 for storing software code or other computer-executed code that is utilized to implement applications, the file system, and the operating system. The storage device 1512 is connected to the processor 1502 through a storage controller (not shown) connected to the bus 1510. The storage device 1512 and its associated computer-readable storage media provide non-volatile storage for the architecture 1500. Although the description of computer-readable storage media contained herein refers to a long-term storage device, such as a hard disk or CD-ROM drive, it may be appreciated by those skilled in the art that computer-readable storage media can be any available storage media that can be accessed by the architecture 1500, including solid stage drives and flash memory.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), Blu-ray, or other optical storage, magnetic cassettes, magnetic tape, magnetic disk storage or other magnetic storage devices, or any other medium which can be used to store the desired information and which can be accessed by the architecture 1500.

According to various embodiments, the architecture 1500 may operate in a networked environment using logical connections to remote computers through a network. The architecture 1500 may connect to the network through a network interface unit 1516 connected to the bus 1510. It may be appreciated that the network interface unit 1516 also may be utilized to connect to other types of networks and remote computer systems. The architecture 1500 also may include an input/output controller 1518 for receiving and processing input from a number of other devices, including a keyboard, mouse, touchpad, touchscreen, control devices such as buttons and switches or electronic stylus (not shown in FIG. 15). Similarly, the input/output controller 1518 may provide output to a display screen, user interface, a printer, or other type of output device (also not shown in FIG. 15).

It may be appreciated that any software components described herein may, when loaded into the processor 1502 and executed, transform the processor 1502 and the overall architecture 1500 from a general-purpose computing system into a special-purpose computing system customized to facilitate the functionality presented herein. The processor 1502 may be constructed from any number of transistors or other discrete circuit elements, which may individually or collectively assume any number of states. More specifically, the processor 1502 may operate as a finite-state machine, in response to executable instructions contained within the software modules disclosed herein. These computer-executable instructions may transform the processor 1502 by specifying how the processor 1502 transitions between states, thereby transforming the transistors or other discrete hardware elements constituting the processor 1502.

Encoding the software modules presented herein also may transform the physical structure of the computer-readable storage media presented herein. The specific transformation of physical structure may depend on various factors in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it may be appreciated that many types of physical transformations take place in the architecture 1500 in order to store and execute the software components presented herein. It also may be appreciated that the architecture 1500 may include other types of computing devices, including wearable devices, handheld computers, embedded computer systems, smartphones, PDAs, and other types of computing devices known to those skilled in the art. It is also contemplated that the architecture 1500 may not include all of the components shown in FIG. 15, may include other components that are not explicitly shown in FIG. 15, or may utilize an architecture completely different from that shown in FIG. 15.

The computing device may further be configured with tamper-resistant hardware 1522 to execute various functions and operations discussed herein, such as the various transmissions performed by the sending computing device or the receiving computing device. The tamper-resistant hardware may be considered a device that is configured to make a private key unavailable outside its enclosure, require an authorization value in order to use its private key, be immutable, and prevent access after too many incorrect authorization value guesses, among other security features. While hardware features are discussed herein, the tamper-resistance may be configured as a hybrid of hardware and software, purely hardware, or purely software. The tamper-resistant device may exhibit signs of attempted corruption or may react when some physical intrusion is attempted. The tamper-resistant hardware may be a trusted platform module (TPM) or implemented as a Trusted Execution Environment (TEE) created as a portion of the exposed processor.

FIG. 16 is a simplified block diagram of an illustrative computer system 1600 such as a remote server, smartphone, tablet computer, laptop computer, or personal computer (PC) which the present disclosure may be implemented. Computer system 1600 includes a processor 1605, a system memory 1611, and a system bus 1614 that couples various system components including the system memory 1611 to the processor 1605. The system bus 1614 may be any of several types of bus structures including a memory bus or memory controller, a peripheral bus, or a local bus using any of a variety of bus architectures. The system memory 1611 includes read only memory (ROM) 1617 and random access memory (RAM) 1621. A basic input/output system (BIOS) 1625, containing the basic routines that help to transfer information between elements within the computer system 1600, such as during startup, is stored in ROM 1617. The computer system 1600 may further include a hard disk drive 1628 for reading from and writing to an internally disposed hard disk, a magnetic disk drive 1630 for reading from or writing to a removable magnetic disk (e.g., a floppy disk), and an optical disk drive 1638 for reading from or writing to a removable optical disk 1643 such as a CD (compact disc), DVD (digital versatile disc), or other optical media. The hard disk drive 1628, magnetic disk drive 1630, and optical disk drive 1638 are connected to the system bus 1614 by a hard disk drive interface 1646, a magnetic disk drive interface 1649, and an optical drive interface 1652, respectively. The drives and their associated computer-readable storage media provide non-volatile storage of computer-readable instructions, data structures, program modules, and other data for the computer system 1600. Although this illustrative example includes a hard disk, a removable magnetic disk 1633, and a removable optical disk 1643, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present disclosure. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, are intended to cover non-transitory embodiments, and does not include waves, signals, and/or other transitory and/or intangible communication media.

A number of program modules may be stored on the hard disk, magnetic disk, optical disk 1643, ROM 1617, or RAM 1621, including an operating system 1655, one or more application programs 1657, other program modules 1660, and program data 1663. A user may enter commands and information into the computer system 1600 through input devices such as a keyboard 1666, pointing device (e.g., mouse) 1668, or touch-screen display 1673. Other input devices may include a microphone, joystick, game pad, satellite dish, scanner, trackball, touchpad, touch-sensitive device, voice-command module or device, user motion or user gesture capture device, or the like. These and other input devices are often connected to the processor 1605 through a serial port interface 1671 that is coupled to the system bus 1614, but may be connected by other interfaces, such as a parallel port, game port, or universal serial bus (USB). A monitor 1673 or other type of display device is also connected to the system bus 1614 via an interface, such as a video adapter 1675. In addition to the monitor 1673, personal computers typically include other peripheral output devices (not shown), such as speakers and printers. The illustrative example shown in FIG. 16 also includes a host adapter 1678, a Small Computer System Interface (SCSI) bus 1683, and an external storage device 1676 connected to the SCSI bus 1683.

The computer system 1600 is operable in a networked environment using logical connections to one or more remote computers, such as a remote computer 1688. The remote computer 1688 may be selected as another personal computer, a server, a router, a network PC, a peer device, or other common network node, and typically includes many or all of the elements described above relative to the computer system 1600, although only a single representative remote memory/storage device 1690 is shown in FIG. 16. The logical connections depicted in FIG. 16 include a local area network (LAN) 1693 and a wide area network (WAN) 1695. Such networking environments are often deployed, for example, in offices, enterprise-wide computer networks, intranets, and the Internet.

When used in a LAN networking environment, the computer system 1600 is connected to the local area network 1693 through a network interface or adapter 1696. When used in a WAN networking environment, the computer system 1600 typically includes a broadband modem 1698, network gateway, or other means for establishing communications over the wide area network 1695, such as the Internet. The broadband modem 1698, which may be internal or external, is connected to the system bus 1614 via a serial port interface 1671. In a networked environment, program modules related to the computer system 1600, or portions thereof, may be stored in the remote memory storage device 1690. It is noted that the network connections shown in FIG. 16 are illustrative and other means of establishing a communications link between the computers may be used depending on the specific requirements of an application of the present disclosure.

Various illustrative implementations are disclosed herein. In one exemplary implementation there is a user computing device, comprising: one or more processors; and one or more hardware-based memory devices having instructions which, when executed by the one or more processors, cause the sending computing device to establish a connection with a point of sale (POS) device to initiate a transaction; transmit a public key to the POS device to initiate a verification process; verify a digital certificate associated with the POS device responsive to transmitting the public key; and upon verifying the POS device's digital certificate, authorize execution of the transaction.

In another example, the user computing device is configured with a digital certificate distinct from the POS device's digital certificate, in which the user computing ‘device’s digital certificate enables the POS device to authenticate the user computing device. As another example, the user computing ‘device’s digital certificate is further configured with information unique to the user computing device or the unique user of the user computing device. In another example, the information includes any one or more of a unique PIN (personal identification code), user biometrics, user date of birth, user name, or user phone number. As another example, the information is transmitted to the POS device with the digital certificate. In another example, the POS device's UI (user interface) exposes the received information associated with the user computing ‘device’s digital certificate for user verification. In another example, further including a physical stamp that is uniquely associated with and identifies the digital certificate associated with the user computing device. In another example, further including a button, in which the execution of the transaction occurs after the user presses the button and the POS device's digital certificate is verified.

In another exemplary embodiment, disclosed is one or more hardware-based memory devices storing computer-executable instructions which, when executed by one or more processors associated with a user computing device, cause the sending computing device to: establish a connection with a point of sale (POS) device to initiate a transaction; transmit a public key to the POS device to initiate a verification process; verify a digital certificate associated with the POS device responsive to transmitting the public key; and upon verifying the POS device's digital certificate, authorize execution of the transaction.

As another example, the user computing device is configured with a digital certificate distinct from the POS device's digital certificate, in which the user computing ‘device’s digital certificate enables the POS device to authenticate the user computing device. In another example, the user computing ‘device’s digital certificate is further configured with information unique to the user computing device or the unique user of the user computing device. As another example, the information includes any one or more of a unique PIN (personal identification code), user biometrics, user date of birth, user name, or user phone number. In another example, the information is transmitted to the POS device with the digital certificate. As another example, the POS device's UI (user interface) exposes the received information associated with the user computing ‘device’s digital certificate for user verification. In another example, further including a physical stamp that is uniquely associated with and identifies the digital certificate associated with the user computing device. As another example, further including a button, in which the execution of the transaction occurs after the user presses the button and the POS device's digital certificate is verified.

In another exemplary embodiment, disclosed is a method performed by a user computing device, comprising: establishing a connection with a point of sale (POS) device to initiate a transaction; transmitting a public key to the POS device to initiate an authentication process; upon the POS device authenticating the user device receiving a public key from the POS device for authentication purposes; verifying the received public key indicates the POS device is authenticated with a payment service provider; and upon verifying the POS device is authenticated with the payment service provider, authorizing execution of the transaction. In another example, the user computing device is configured with a digital certificate distinct from the POS device's digital certificate, in which the user computing ‘device’s digital certificate enables the POS device to authenticate the user computing device. As another example, the user computing ‘device’s digital certificate is further configured with information unique to the user computing device or the unique user of the user computing device. As another example, subsequent communications between the user device and the POS device are performed using a Diffie-Hellman key exchange based on the exchanged public keys.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A user computing device, comprising:
one or more processors; and
one or more hardware-based memory devices having instructions which, when executed by the one or more processors, cause the sending computing device to:
establish a connection with a point of sale (POS) device to initiate a transaction;
transmit a public key to the POS device to initiate a verification process;
verify a digital certificate associated with the POS device responsive to transmitting the public key; and
upon verifying the POS device's digital certificate, authorize execution of the transaction.

2. The user computing device of claim 1, wherein the user computing device is configured with a digital certificate distinct from the POS device's digital certificate, in which the user computing ‘device’s digital certificate enables the POS device to authenticate the user computing device.

3. The user computing device of claim 2, wherein the user computing ‘device’s digital certificate is further configured with information unique to the user computing device or the unique user of the user computing device.

4. The user computing device of claim 3, wherein the information includes any one or more of a unique PIN (personal identification code), user biometrics, user date of birth, user name, or user phone number.

5. The user computing device of claim 4, wherein the information is transmitted to the POS device with the digital certificate.

6. The user computing device of claim 5, wherein the POS device's UI (user interface) exposes the received information associated with the user computing ‘device’s digital certificate for user verification.

7. The user computing device of claim 2, further comprising a physical stamp that is uniquely associated with and identifies the digital certificate associated with the user computing device.

8. The user computing device of claim 1, further comprising a button, in which the execution of the transaction occurs after the user presses the button and the POS device's digital certificate is verified.

9. One or more hardware-based memory devices storing computer-executable instructions which, when executed by one or more processors associated with a user computing device, cause the sending computing device to:
establish a connection with a point of sale (POS) device to initiate a transaction;
transmit a public key to the POS device to initiate a verification process;
verify a digital certificate associated with the POS device responsive to transmitting the public key; and
upon verifying the POS device's digital certificate, authorize execution of the transaction.

10. The one or more hardware-based memory devices of claim 9, wherein the user computing device is configured with a digital certificate distinct from the POS device's digital certificate, in which the user computing ‘device’s digital certificate enables the POS device to authenticate the user computing device.

11. The one or more hardware-based memory devices of claim 10, wherein the user computing ‘device’s digital certificate is further configured with information unique to the user computing device or the unique user of the user computing device.

12. The one or more hardware-based memory devices of claim 11, wherein the information includes any one or more of a unique PIN (personal identification code), user biometrics, user date of birth, user name, or user phone number.

13. The one or more hardware-based memory devices of claim 12, wherein the information is transmitted to the POS device with the digital certificate.

14. The one or more hardware-based memory devices of claim 13, wherein the POS device's UI (user interface) exposes the received information associated with the user computing ‘device’s digital certificate for user verification.

15. The one or more hardware-based memory devices of claim 10, further comprising a physical stamp that is uniquely associated with and identifies the digital certificate associated with the user computing device.

16. The one or more hardware-based memory devices of claim 9, further comprising a button, in which the execution of the transaction occurs after the user presses the button and the POS device's digital certificate is verified.

17. A method performed by a user computing device, comprising:
establishing a connection with a point of sale (POS) device to initiate a transaction;
transmitting a public key to the POS device to initiate an authentication process;
upon the POS device authenticating the user device receiving a public key from the POS device for authentication purposes;
verifying the received public key indicates the POS device is authenticated with a payment service provider; and
upon verifying the POS device is authenticated with the payment service provider, authorizing execution of the transaction.

18. The method of claim 17, wherein the user computing device is configured with a digital certificate distinct from the POS device's digital certificate, in which the user computing ‘device’s digital certificate enables the POS device to authenticate the user computing device.

19. The method of claim 18, wherein the user computing ‘device’s digital certificate is further configured with information unique to the user computing device or the unique user of the user computing device.

20. The method of claim 17, wherein subsequent communications between the user device and the POS device are performed using a Diffie-Hellman key exchange based on the exchanged public keys.
